(19) United States
(12) Patent Application Publication
(10) Pub. No.: US 2004/0209653 A1
(43) Pub. Date: Oct. 21, 2004

(54) Incorporating customer defined digit substitutes into standard wireless voice activated dialing processes

(75) Inventor: Catherine J. Chandhok, Troy, MI (US)

Correspondence Address: ANTHONY LUKE SIMON, General Motors Corporation, Legal Staff, Mail Code 482-C23-B21, P.O. Box 300, Detroit, MI, 48265-3000, US

(73) Assignee: General Motors Corporation

(21) Appl. No.: 10/413,791

(22) Filed: Apr. 15, 2003

(51) Int. Cl. H04M 1/00; H04B 1/38

(52) U.S. Cl. 455/563; 455/550.1

(57) ABSTRACT

The present invention provides a method, system, and computer usable medium for incorporating customer defined digit substitutes into standard wireless voice activated dialing processes to increase efficiency. The method includes receiving an actuation input to activate a custom dialing configuration mode, prompting a user for a digit substitute for a digit, receiving a digit substitute input and linking the digit substitute input with the digit in a database. The invention also provides a system for performing the method. Further, the system includes a computer usable medium with computer useable code for incorporating the customer defined digit substitutes into the dialing process.

### FIELD OF THE INVENTION

This invention relates generally to assisting standard wireless voice activated dialing processes. In particular this invention relates to a method and system for incorporating customer defined digit substitutes into standard wireless voice activated dialing processes to increase efficiency.

### BACKGROUND OF THE INVENTION

A current problem with standard wireless voice activated dialing processes has to do with voice recognition problems. It is known generally that voice recognition systems are more effective at recognizing longer words than shorter words. It would be more effective to enable the user to articulate longer words of their own choice to substitute for shorter words that are harder to recognize, e.g. “two for the money” instead of “two.”

Currently, speakers of foreign languages may be hindered by having to use the English language based dialing system in standard wireless voice activated dialing processes. Therefore, it would also be more effective to enable the user to articulate words of their own language to substitute for the English language system inherent to standard wireless voice activated dialing processes, e.g. “uno” instead of “one”, “dos” instead of “two”, etc. These benefits would increase user satisfaction with standard wireless voice activated dialing processes and would increase the number of calls made using the system.

Therefore, it would be desirable to provide a method for incorporating customer defined number substitutes into standard wireless voice activated dialing processes to increase efficiency.

### SUMMARY OF THE INVENTION

A method for incorporating customer defined digit substitutes into standard wireless voice activated dialing processes to increase efficiency is provided. The method comprises receiving an actuation input to activate a custom dialing configuration mode, prompting a user for a digit substitute for a digit, receiving a digit substitute input and linking the digit substitute input with the digit in a database.

A computer usable medium including a program for incorporating customer defined digit substitutes into standard wireless voice activated dialing processes is also provided. The computer usable medium includes computer readable code for receiving an actuation input to activate a custom dialing, configuration mode, computer readable code for prompting a user for a digit substitute for a digit, computer readable code for receiving a digit substitute input and computer readable code for linking the digit substitute input with the digit in a database.

A system for incorporating customer defined digit substitutes into standard wireless voice activated dialing processes is also provided. The system includes means for receiving an actuation input to activate a custom dialing configuration mode, means for prompting a user for a digit substitute for a digit, means for receiving a digit substitute input and means for linking the digit substitute input with the digit in a database.

The foregoing and other features and advantages of the invention will become further apparent from the following detailed description of the presently preferred embodiment, read in conjunction with the accompanying drawings. The detailed description and drawings are merely illustrative of the invention rather than limiting, the scope of the invention being defined by the appended claims and equivalents thereof.

### BRIEF DESCRIPTION OF THE DRAWINGS

FIG. 1 is a schematic diagram of a system for communicating from a vehicle to a service provider in accordance with the present invention;

FIG. 2 is a flow diagram of one embodiment of a method for incorporating customer defined digit substitutes into standard wireless voice activated dialing processes to increase efficiency for the system of FIG. 1, in accordance with the present invention; and

FIG. 3 is a flow diagram of one embodiment of a method for using the custom defined digit substitutes for the use in standard wireless voice activated dialing processes for the system of FIG. 1, in accordance with the present invention.

### DETAILED DESCRIPTION OF THE PRESENTLY PREFERRED EMBODIMENTS

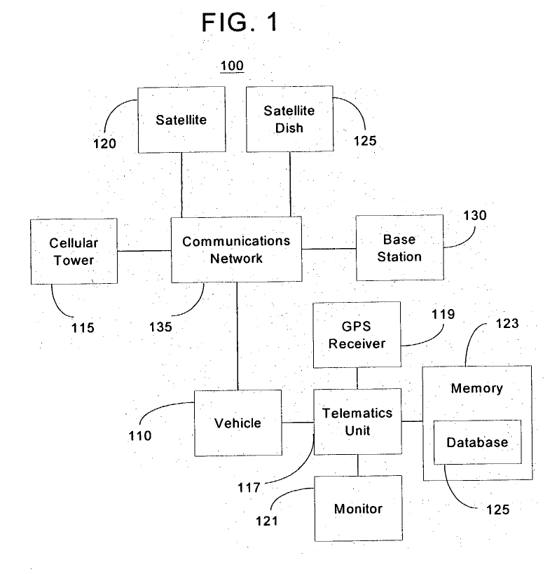

FIG. 1 shows one embodiment of a system for communicating from a vehicle to a service provider in accordance with the present invention at 100. The system 100 may include one or more vehicle clients 110, one or more carrier systems, 115, 120, 125, one or more communications networks or wide area networks (WAN) 135, and one or more base stations 130.

Vehicle client 110 may be any suitable vehicle, for example, an automobile, bus, or train. Associated with the vehicle client 110 is a telematics unit 117 that is capable of providing remote services to the vehicle via a wireless communications link with one or more base stations 130.

The telematics unit 117 is comprised of a GPS receiver 119, a software monitor 121, memory 123 associated with the software monitor, and an area of memory reserved for a database 125. The database 125 contains user defined digit substitutes for the system number used by a standard wireless voice activated dialing process.

The telematics unit 117 includes a standard Wireless voice activated dialing process. The telematics unit 117 also includes any suitable hardware and software for transmitting and receiving voice and data communications, as is well known in the art. One embodiment of the telematics unit 117 includes any suitable hardware necessary for a custom dialing configuration mode within a voice activated dialing process. Another embodiment of the telematics unit 117 includes any suitable hardware necessary for continuous digit dial, discrete digit dial, or both.

The software monitor 121 associated with the telematics unit 117 contains software necessary for a custom dialing configuration mode within a voice activated dialing process. The software monitor 121 also contains software for continuous digit dial, discrete digit dial, or both. Continuous digit dial consists of the user speaking the entire ten numbers of the telephone number they wish to dial, one number at a time. For either method of dialing, the numbers being spoken consist of digits, customer defined digit substitutes, or both.

The telematics unit 119 contains memory 123 capable of storing digits spoken by the user in discrete digit dial mode. The digits are system digits, or system digits represented by digits substitutes. System digits consist of Arabic numerals zero through nine. The memory 123 is emptied after the successful completion of a call in discrete digit dial mode. The memory comprises any suitable hardware or software configuration, or combination thereof for storing numbers.

The telematics unit 117 also contains a database 125. The database 125 stores customer defined digit substitutes for the system digits used by the wireless voice activated dialing process. The database 125 is contained within the memory 123 associated with the telematics unit 119. The database 123 comprises any suitable hardware or software configuration, or combination thereof for mapping system digits to their defined system substitutes.

The carrier system 115, 120, 125 is any suitable system for transmitting a signal between the telematics system 117 and the base station 130 via a communications network 135. In one embodiment of the invention the carrier may be a digital wireless carrier system 115 such as a personal communications system (PCS), a global system for mobile communication (GSM), a code division multiple access (CDMA) system, a time division multiple access (TDMA) system, or the like. In another embodiment of the invention, the carrier link may be a link to one or more satellites 120 that are in communication with one or more base satellite dish receivers 125. In yet another embodiment of the invention, the carrier system is a link to one or more satellites 120 that relay signals between one or more satellites 120 before communicating with one or more base satellite dish receivers 125. Other examples of a carrier system are radio links such as microwave, citizen's band (CB), dedicated radio systems such as police, military, or any other suitable radio communications link. The carrier system includes any suitable hardware or software configuration, or combination thereof.

Communications network 135 is any suitable system for communicating between vehicle client 110 or carrier systems 115,120,125 and base station 130. In one embodiment of the invention the communications network 135 can be a public switched telephone network (PTSN). In another embodiment of the invention, the communications network 135 can be a multi-protocol Internet protocol (IP) network such as Internet, extranet, private network, virtual private network (VPN), or any other wide area network (WAN) capable of carrying voice and/or digital data in either digital and/or analog format. Alternatively the communications network 135 can be a hybrid or virtual communication network. The communications network 135 includes any suitable hardware or software configuration, or combination thereof, to communicate between vehicle client 110 or carrier systems 115, 120, 125 and base station 130.

Base station 130 is available to communicate with vehicle client 110 via the communications network 135. Base station 130 consists of any networked system that provides remote service to telematics system 117. Base station 130 includes any suitable hardware or software, or combination, thereof to respond to the requests of vehicle client 110.

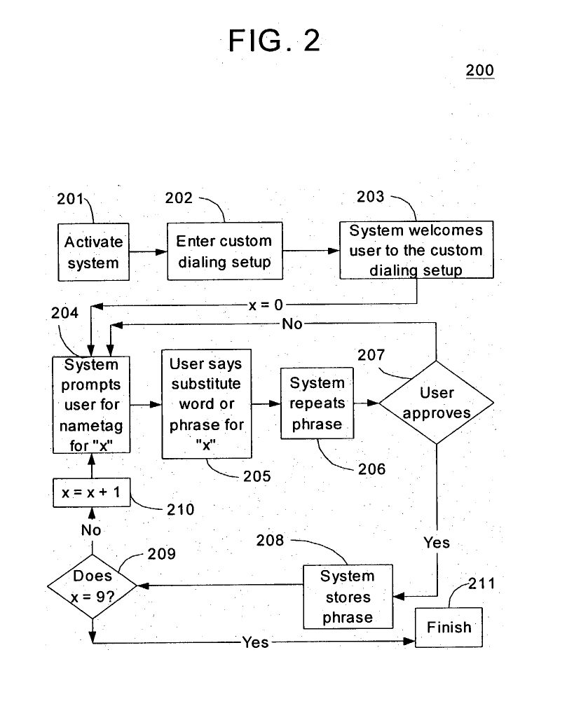

Referring now to FIG. 1 and FIG. 2, one embodiment of a method for incorporating customer defined digit (number) substitutes into standard wireless voice activated dialing processes in accordance with the present invention is shown at 200. One embodiment of a standard wireless voice activated dialing process is OnStar Personal Calling. In one embodiment, the standard wireless voice activated dialing process is activated by pressing a button, (Block 201). Once the dialing process is activated, the user may enter the custom dialing configuration mode by saying, “Custom dialing setup”, (Block 202). In another embodiment, the user may enter the custom dialing setup by pressing a button on a display screen.

The system says, using a preprogrammed script “Welcome to custom dialing setup”, (Block 203), and then prompts the user to, “Please enter your custom nametag for the number zero,” (Block 204). The user then says their substitute phrase for the number zero, (Block 205). This phrase can be any word or group of words in any language, for example “one for the money.” The user's substitute phrase is recorded. The system repeats the substitute word or phrase and asks the user for verification, (Block 206). The user then evaluates the word or phrase repeated by the system, (Block 207), and accepts or rejects it. If the user rejects the word or phrase by saying “no,” the system returns to Block 204, where the user will be prompted to reenter their digit substitute. If the user accepts the word or phrase by saying “yes,” the user proceeds to Block 208, where the system stores the digit substitute “one for the money” for the number zero. The digit substitute will be stored in the telematics unit 117.

After the system stores the digit substitute, the system checks to see if the user has just substituted a word or phrase for the number nine, (Block 209). If it has, the custom dialing setup will be complete, (Block 211). If the current number is not nine, the number will be incremented by one, (Block 210), and the user will then be prompted to enter the substitute for that number. The method proceeds through the steps of Blocks 204-210 until a digit substitute has been entered for all of the numbers from zero to nine. In another embodiment, the user may enter custom substitutes for less than all ten numbers, zero to nine.

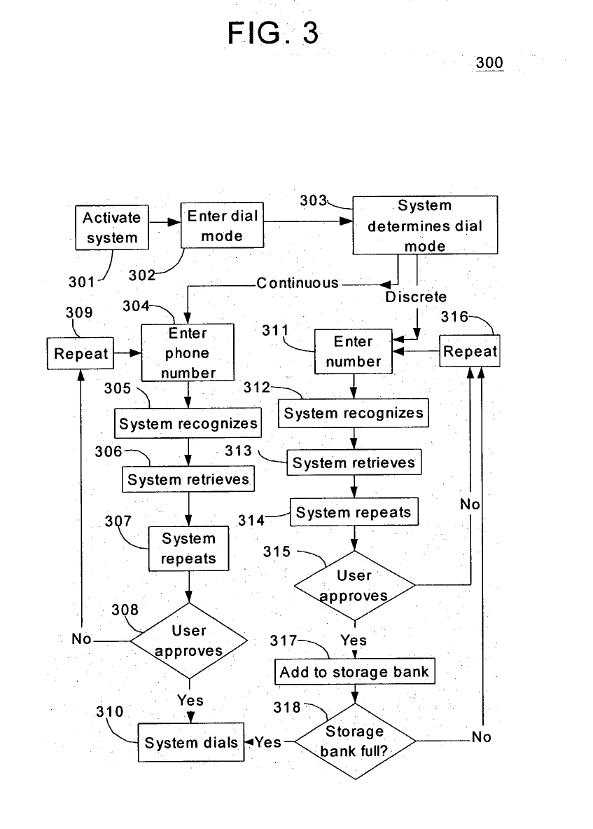

The custom dialing configuration completed in FIG. 2 may then be used in the custom dialing process depicted in FIG. 3.

Referring now to FIG. 3, one embodiment of a method for using the custom defined digit substitutes for use in standard wireless voice activated dialing processes in accordance with the present invention is shown at 300. One embodiment of a standard wireless voice activated dialing process is OnStar Personal Calling. The standard wireless voice activated dialing process is activated by pressing a button, (Block 301). To enter the custom dialing mode, the user says, “Custom dial”, (Block 302). The system then determines from a current configuration setting whether the system is continuous dial or discrete digit dial, (Block 303).

If continuous dial is used, the system prompts the user to enter the telephone number they wish to dial. The user then enters a string of system digit and digit substitutes representing the entire telephone number to be dialed, (Block 304). For each digit, the system will determine if it recognizes the digit as a system digit, (Block 305). If the digit is not a system digit, the system will check the database for the digit substitute. The system digit represented by this digit substitute will then be retrieved from the database, (Block 306). The system will then store the system digit in the storage bank until each digit has been evaluated. When each digit has been evaluated, the system repeats the string of system digit, (Block 307), and then the user evaluates the string of system digit, (Block 308). If the user rejects all or part of the telephone number by saying “no,” the system prompts the user to repeat the telephone number, (Block 309). If the user accepts the telephone number by saying yes, however, the system dials the string of system digits, (Block 310).

If the system is discrete digit dial, the user will be prompted to enter the telephone number, one digit at a time. The user will then enter a single system digit or digit substitute, (Block 311). The system will determine if it recognizes the digit as a system digit, (Block 312). If the digit is not a system digit, the system will check the database for the digit substitute. The system digit represented by this digit substitute will then be retrieved from the database, (Block 313). The system will then repeat the system digit, (Block 314), and ask the user for verification, (Block 315). If the user rejects the system digit by saying “no,” they will be prompted to reenter their system digit or digit substitute, (Block 316). If the user accepts the system digit by saying “yes,” the user proceeds to Block 317, where the system adds the system digit to a storage bank. The storage bank is located in the telematics unit 117. The system will then check to see if the storage bank is full, (Block 318). If the storage bank is full, i.e. consists of the ten system digits required to place a telephone call, the system will dial the telephone number, (Block 310). If the storage bank is not full, the user will be returned to Block 316, where they will be prompted to enter the next system digit or digit substitute. Blocks 311-318 will continue until the storage bank is full, at which time the method proceeds to Block 310.

While the embodiments of the present invention disclosed herein are presently considered to be preferred, various changes and modifications can be made without departing from the spirit and scope of the invention. The scope of the invention is indicated in the appended claims, and all changes that come within the meaning and range of equivalents are intended to be embraced therein.

What is claimed is:

1. A method for incorporating customer defined digit substitutes into a voice activated dialing process comprising:
receiving an custom dialing actuation input;
prompting a user for a digit substitute for at least one digit responsive to the custom dialing actuation input;
receiving a digit substitute input from the user; and
linking the digit substitute input with the digit in a database.

2. The method of claim 1 further comprising:
playing a recorded version of the received digit substitute back to the user; and
prompting the user to accept or reject the repeated digit substitute.

3. The method of claim 1 wherein receiving the actuation input comprises pressing an activation button.

4. The method of claim 1 wherein receiving the actuation input comprises receiving a verbal command from the user.

5. The method of claim 1 wherein prompting the user for a digit substitute for a digit comprises prompting the user for a digit substitute for each digit zero to nine.

6. The method of claim 1 wherein the database is located in a vehicle telematics unit.

7. The method of claim 1 wherein receiving a digit substitute input comprises the user verbally communicating the digit substitute.

8. The method of claim 1 further comprising:
receiving an actuation input to activate a voice activated dialing process;
determining a voice activated dialing process dialing type;
prompting the user to verbally communicate a telephone number;
receiving the verbally communicated telephone number; and
dialing the telephone number.

9. The method of claim 8 wherein the voice activated dialing process dialing type of the voice activated dialing process comprises discrete digit dialing.

10. The method of claim 9 wherein prompting the user to verbally communicate a telephone number comprises:
prompting the user to speak a single digit or digit substitute of the telephone number.

11. The method of claim 10 further comprising:
recognizing each spoken digit or digit substitute;
correlating the spoken digit substitute with a digit;
repeating to the user each digit spoken by the user or digit represented by the digit substitute spoken by the user;
prompting the user to accept or reject the repeated digit; and
storing the digit after accepted.

12. The method of claim 11 further comprising:
prompting the user to restate the digit or digit substitute after the user rejects the repeated digit.

13. The method of claim 11 further comprising:
prompting the user for the next digit or digit substitute of the telephone number when the user accepts the repeated digit.

14. The method of claim 8 wherein the voice activated dialing process dialing type of the voice activated dialing process is continuous digit dial.

15. The method of claim 14 wherein verbally communicating the telephone number consists of:
prompting the user to speak each individual digit or digit substitute of the telephone number.

16. The method of claim 15 further comprising:
recognizing each digit or digit substitute of the telephone number;
correlating each digit substitute with an appropriate digit;
repeating to the user each digit of the telephone number; and
prompting the user to accept or reject the telephone number.

17. A computer usable medium including a program for incorporating customer defined number substitutes into a voice activated dialing process comprising:
computer readable code for receiving an actuation input to activate a custom dialing configuration mode;
computer readable code for prompting a user for a digit substitute for a digit;
computer readable code for receiving a digit substitute input; and
computer readable code for linking the digit substitute input with the digit in a database.

18. The medium of claim 17 further comprising:
computer readable code for repeating the received digit substitute back to the user; and
computer readable code for prompting the user to accept or reject the repeated digit substitute.

19. The computer usable medium of claim 17 further comprising:
computer readable code for receiving an actuation input to activate a voice activated dialing process;
computer readable code for determining a voice activated dialing process dialing type;
computer readable code for prompting the user to verbally communicate a telephone number;
computer readable code for receiving the verbally communicated telephone number; and
computer readable code for dialing the telephone number.

20. The computer usable medium of claim 19 wherein the voice activated dialing process dialing type of the voice activated dialing process comprises discrete digit dialing.

21. The computer usable medium of claim 20 wherein prompting the user to verbally communicate a telephone number comprises:
computer readable code for prompting the user to speak a single digit or digit substitute of the telephone number.

22. The computer usable medium of claim 21 further comprising:
computer readable code for recognizing each spoken digit or digit substitute;
computer readable code for correlating the spoken digit substitute with a digit;
computer readable code for repeating to the user each digit spoken by the user or digit represented by the digit substitute spoken by the user;
computer readable code for prompting the user to accept or reject the repeated digit; and
computer readable code for storing the digit after accepted.

23. The computer usable medium of claim 22 further comprising:
computer readable code for prompting the user to restate the digit or digit substitute after the user rejects the repeated digit.

24. The computer usable medium of claim 22 further comprising:
computer readable code for prompting the user for the next digit or digit substitute of the telephone number when the user accepts the repeated digit.

25. The computer usable medium of claim 19 wherein the voice activated dialing process dialing type of the voice activated dialing process is continuous digit dial.

26. The computer usable medium of claim 25 wherein verbally communicating the telephone number consists of:
computer readable code for prompting the user to speak each individual digit or digit substitute of the telephone number.

27. The computer usable medium of claim 26 further comprising:
computer readable code for recognizing each digit or digit substitute of the telephone number;
computer readable code for correlating each digit substitute with an appropriate digit;
computer readable code for repeating to the user each digit of the telephone number; and
computer readable code for prompting the user to accept or reject the telephone number.

28. A system for incorporating customer defined digit substitutes into a voice activated dialing process comprising:
means for receiving an actuation input to activate a custom dialing configuration mode;
means for prompting a user for a digit substitute for at least one digit;
means for receiving a digit substitute input; and
means for linking the digit substitute input with the digit in a database.
